(19) United States
(12) Patent Application Publication
(10) Pub. No.: US 2015/0213134 A1
(43) Pub. Date: Jul. 30, 2015

(54) DATA QUERY METHOD AND SYSTEM AND STORAGE MEDIUM

(71) Applicant: TENCENT TECHNOLOGY (SHENZHEN) COMPANY LIMITED, Shenzhen (CN)

(72) Inventors: JING NIE, Shenzhen (CN); YONG HU, Shenzhen (CN); PENG HE, Shenzhen (CN); MINHAO HUANG, Shenzhen (CN)

(73) Assignee: TENCENT TECHNOLOGY (SHENZHEN) COMPANY LIMITED

(21) Appl. No.: 14/681,284

(22) Filed: Apr. 8, 2015

Related U.S. Application Data
(63) Continuation of application No. PCT/CN2013/082082, filed on Aug. 22, 2013.

(30) Foreign Application Priority Data
Oct. 11, 2012 (CN) 2012-10384514.2

(51) Int. Cl. G06F 17/30; G06F 15/167

(52) U.S. Cl. CPC G06F 17/30864; G06F 15/167

(57) ABSTRACT

The present disclosure discloses a data query system, method, and storage medium. The data query system includes a proxy server and at least one proxy client. The proxy server is disposed on a server that serves as a data provider, and is configured to provide the proxy client with a data delivery service. The proxy client is disposed on a client that serves as a data user, and is configured to obtain data from the proxy server and save the data and provide a data query service. The proxy client thus includes a data obtaining module, a data query module, and a second shared memory. Accordingly, the present disclosure further discloses a data query method. The present disclosure has a simple structure, achieves fast data update, requires a low deployment cost, saves bandwidth resources, and achieves excellent service performance.

### CROSS-REFERENCES TO RELATED APPLICATIONS

This application is a continuation of PCT Application No. PCT/CN2013/082082, filed on Aug. 22, 2013, which claims priority to Chinese Patent Application No. CN 201210384514.2, filed on Oct. 11, 2012, the entire contents of all of which are incorporated herein by reference.

### FIELD OF THE TECHNOLOGY

Embodiments of the present invention relate to data query technologies, and more particularly, relates to a data query method and system and a storage medium.

### BACKGROUND OF THE DISCLOSURE

In the existing technologies, an Internet Protocol (IP) data query from a client is mainly implemented by a network structure shown in FIG. 1. The network structure includes an IP database push system and clients. The IP database push system may include a query server cluster consisting of multiple query servers, a query controller configured to control and manage the query servers, an interface server cluster consisting of multiple interface servers, and an interface controller configured to control and manage the interface servers.

An existing IP database push system and IP data query method for IP data query have the following defects.

First, in the IP database push system, a single IP data query needs to be performed by interface servers and data query servers together, and a query controller configured to control the query servers and an interface controller configured to control the interface servers need to be configured, resulting in a complex structure. Besides, since each query server has a limited unit data search capacity (representing the number of queries per second externally provided by one server), it is necessary to deploy a large number of servers to provide massive data query services, causing a high deployment cost. Further, it takes a long time to perform protocol debugging in service development, so the service performance is poor.

Second, in the existing IP data query, it is necessary to transmit a large number of query requests and query results in a single IP data query, so a lot of bandwidth resources are consumed. A rollback mechanism is absent, so that, if an error occurs in a computing system and erroneous data is pushed, an applier uses the erroneous data directly. Rollback cannot be performed.

Third, when a client raises an IP data query, it is necessary to develop locally a corresponding query tool and a tool that is configured to import IP data in a query request returned by the IP database push system into a local database, so a lot of repetitive development is required, which wastes resources and increases the deployment cost for IP data query.

Therefore, there is a need to solve technical problems in the Internet and computer technology having a complex system structure, a high deployment cost, poor service performance, and overconsumption of resources in IP data query.

### SUMMARY

An objective of embodiments of the present invention is to provide a data query method and system and storage medium, so as to solve the problems such as a complex system structure, a high deployment cost, poor service performance, and overconsumption of resources in IP data query.

In order to achieve the objective, technical solutions of the embodiments of the present invention are as follows. One aspect or embodiment of the present disclosure provides a data query system. The data query system including: a proxy server and at least one proxy client. The proxy server is disposed on a server that serves as a data provider, and is configured to provide the proxy client with a data delivery service. The proxy client is disposed on a client that serves as a data user, and is configured to obtain data from the proxy server and save the data and provide a data query service. The proxy client includes a data obtaining module, a data query module, and a second shared memory. The data obtaining module is configured to initiate a data obtaining request for obtaining specified data from the proxy server, receive the specified data returned by the proxy server, and write the specified data into a second shared memory. The data query module is configured to query data specified by an applier from the second shared memory, and return the data to the applier. The second shared memory is configured to store the data written by the data obtaining module and to be queried by the data query module.

Another aspect or embodiment of the present disclosure provides a data query method implemented by a data query system. The data query system is provided to include a proxy server and at least one proxy client. The proxy server is disposed on a server that serves as a data provider, and provides the proxy client with a data delivery service. The proxy client is disposed on a client that serves as a data user, and obtains data from the proxy server and saves the data and provides a data query service by a following process. A data obtaining module of the proxy client initiates a data obtaining request for obtaining specified data from the proxy server, receives the specified data returned by the proxy server, and writes the specified data into a second shared memory. A data query module of the proxy client queries data specified by an applier from the second shared memory, and returns the data to the applier.

Another aspect or embodiment of the present disclosure provides a non-transitory computer readable storage medium, having a program stored thereon. When being executed, the program causes one or more processors of a proxy client to perform a data query method. In the data query method, a data obtaining module of the proxy client initiates a data obtaining request for obtaining specified data to a proxy server, receives the specified data returned by the proxy server, and writes the specified data into a second shared memory. A data query module of the proxy client queries data specified by an applier from the second shared memory, and returns the data to the applier.

In the data query system and method and the storage medium in the embodiments of the present invention, a proxy server is disposed on a server that serves as a data provider, at least one proxy client is disposed on a client that serves as a data user, the proxy server provides the proxy client with a data delivery service, and the proxy client obtains data from the proxy server and saves the data and provides a data query service. The data query system in the embodiments of the present invention only requires the proxy server and the proxy client, and the proxy client can exchange data with the proxy server directly, so the structure is simple, and data is updated quickly.

Additionally, in the embodiments of the present invention, when an applier on the client needs to query data, the applier only needs to query locally saved data by using the proxy client, which can avoid the influence of a network exception and network bandwidth on data query and avoid bandwidth waste during data transmission, save bandwidth resources, and break a bottleneck of the network bandwidth. Moreover, it is unnecessary to develop any new query service tool on the applier, thereby achieving a low deployment cost. In the embodiments of the present invention, the proxy server and the proxy client can exchange massive data, thereby achieving excellent service performance.

Other aspects or embodiments of the present disclosure can be understood by those skilled in the art in light of the description, the claims, and the drawings of the present disclosure.

### BRIEF DESCRIPTION OF THE DRAWINGS

To describe the technical solutions of the embodiments of the present invention or the existing technologies more clearly, the following briefly introduces the accompanying drawings required for describing the embodiments or the existing technologies. Apparently, the accompanying drawings in the following description show only some embodiments of the present invention, and a person of ordinary skill in the art may still derive other drawings from these accompanying drawings without creative efforts. In these accompanying drawings:

FIG. 1 is a schematic diagram of a network structure for IP data query in the existing technologies;

FIG. 2 is a schematic diagram of a constituent structure of a data query system according to an embodiment of the present invention;

FIG. 3 is a schematic diagram of a specific constituent structure of the data query system according to the embodiment of the present invention;

FIG. 4 is a flowchart of a data query method according to an embodiment of the present invention;

FIG. 5 is a flowchart of an implementation process of applying the query method according to the embodiment of the present invention to IP data query;

FIG. 6 illustrates an exemplary environment incorporating certain disclosed embodiments; and

FIG. 7 illustrates an exemplary server consistent with the disclosed embodiments.

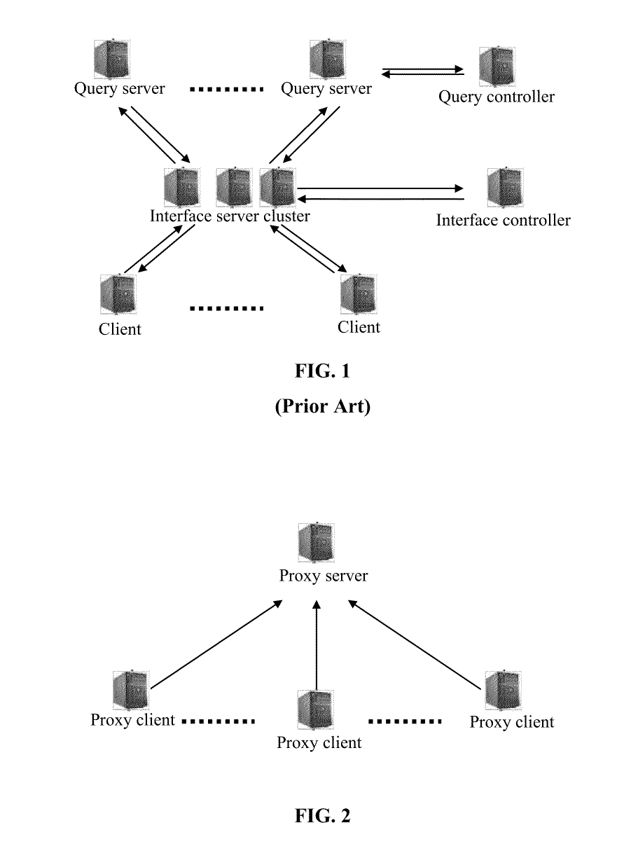

### DETAILED DESCRIPTION OF EMBODIMENTS

Reference will now be made in detail to exemplary embodiments of the disclosure, which are illustrated in the accompanying drawings. Wherever possible, the same reference numbers will be used throughout the drawings to refer to the same or like parts.

A data query system is provided in an embodiment of the present invention. The system includes a proxy server and at least one proxy client. The proxy server is located on a server side that serves as a provider, and is configured to provide a service such as data delivery. The proxy client is located on a client side that serves as an applier (e.g., an application user), and is configured to obtain specified data from the proxy server and provide the applier with a data query service.

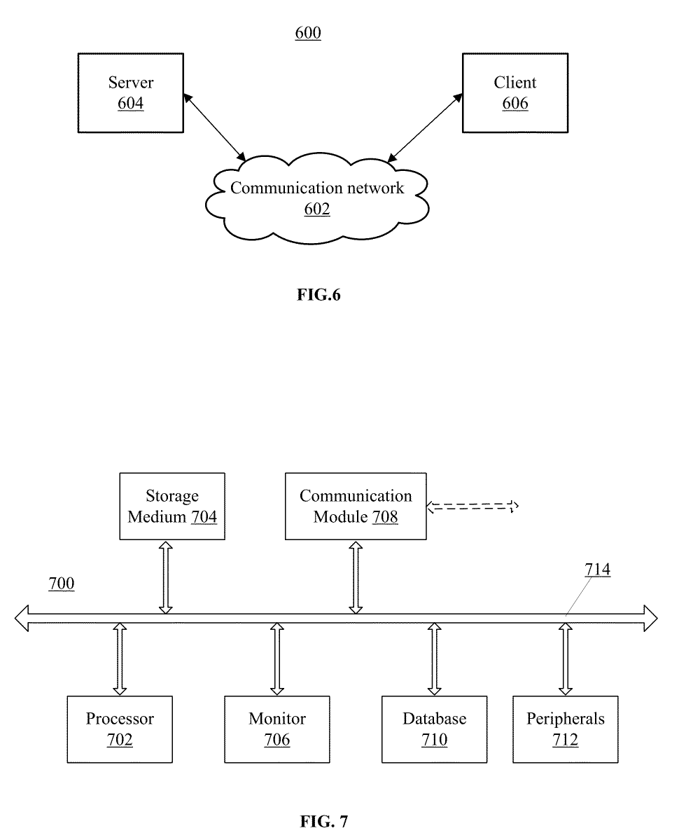

FIG. 6 illustrates an exemplary environment 600 incorporating certain disclosed embodiments of the present invention. As shown in FIG. 6, environment 600 may include a server 604, a client 606, and a communication network 602. The server 604 and the client 606 may be coupled through the communication network 602 for information exchange, such as Internet data searching. Although only one client 606 and one server 604 is shown in the environment 600, any number of clients 606 or servers 604 may be included, and other devices may also be included.

Communication network 602 may include any appropriate type of communication network for providing network connections to the server 604 and client 606 or among multiple servers 604 or clients 606. For example, communication network 602 may include the Internet or other types of computer networks or telecommunication networks, either wired or wireless.

A client, as used herein, may refer to any appropriate user terminal with certain computing capabilities, such as a personal computer (PC), a work station computer, a server computer, a hand-held computing device (tablet), a smart phone or mobile phone, or any other user-side computing device. For example, the client 606 may include a proxy client configured in data query systems as disclosed herein.

A server, as used herein, may refer one or more server computers configured to provide certain server functionalities, such as database management and search engines. For example, the client 606 may include a proxy server configured in data query systems as disclosed herein.

In various embodiments, the client and/or the server may include a computing device such as a computer, and each may also include one or more processors to execute computer programs in parallel. FIG. 7 shows a block diagram of an exemplary computing device.

As shown in FIG. 7, the computing device may include a processor 702, a storage medium 704, a monitor 706, a communication module 708, a database 710, peripherals 712, and one or more bus 714 to couple the devices together. Certain devices may be omitted and other devices may be included.

Processor 702 may include any appropriate processor or processors. Further, processor 702 can include multiple cores for multi-thread or parallel processing. Storage medium 704 may include memory modules, such as ROM, RAM, and flash memory modules, and mass storages, such as CD-ROM, U-disk, removable hard disk, etc. Storage medium 704 may store computer programs for implementing various processes, when executed by processor 702. Storage medium 704 may be a non-transitory computer readable storage medium.

Further, peripherals 712 may include I/O devices such as keyboard and mouse, and communication module 708 may include network devices for establishing connections through the communication network 602. Database 710 may include one or more databases for storing certain data and for performing certain operations on the stored data, such as database searching.

In an exemplary operation, client 606 may cause server 604 to perform certain actions, such as an Internet search or other database operations. Server 604 may be configured to provide structures and functions for such actions and operations. More particularly, server 604 may include a data searching/querying system for real-time database searching. The real-time database searching/querying functionality may be realized by separating a server database into a plurality of databases each having a fixed upper limit on the database capacity, i.e., maximum capacity. Thus, instead of creating indices for a single large database, which may be a large number, indices of the plurality of smaller databases can be created with substantially less amount of time.

A constituent structure of a data query system according to an embodiment of the present invention is shown in FIG. 2, and may mainly include: a proxy server and at least one proxy client. The proxy server is disposed on a server that serves as a data provider, and is configured to provide the proxy client with a data delivery service. The proxy client is disposed on a client that serves as a data user, and is configured to obtain data from the proxy server and save the data and provide a data query service. In one embodiment, the proxy server and the proxy client exchange data by using a general data request (Ask) protocol.

Specifically, as shown in FIG. 3, the proxy server may include: a data downloading (load_data) module, a data service module, and a first shared memory. The data downloading module is configured to obtain from outside (for example, a data computing system, such as an IP data computing system capable of obtaining a data file) a data file, and write data in the data file into the first shared memory. The first shared memory is configured to store the data written by the data downloading module and to be queried by the data service module. The data service module is configured to receive a data obtaining request initiated by the proxy client, to read specified data from the first shared memory according to the data obtaining request, and then to send the specified data to the proxy client by using a network.

The first shared memory includes two parts: an index segment and a data segment. The index segment is configured to save version information and an index number (Seq) of data, and the data segment is configured to save data. Here, after obtaining the data file from the data computing system, the data downloading module performs rewriting in the index segment in the first shared memory according to version information and an index number (Seq) of the data file, and writes the data in the data file into the data segment of the first shared memory.

In practical application, the data downloading module may initiatively read the data file from the data computing system, or the data computing system may initiatively deliver the data file to the data downloading module.

Specifically, as shown in FIG. 3, the proxy client may include: a data query module, a data obtaining module, and a second shared memory. The data obtaining module is configured to initiate a data obtaining request for obtaining specified data to the proxy server, receive the specified data returned by the proxy server, and write the specified data into the second shared memory. The data query module is configured to query data specified by an applier from the second shared memory, and return the data to the applier. The second shared memory is configured to store the data written by the data obtaining module and to be queried by the data query module.

In various embodiments, the second shared memory is the same as the first shared memory, and also includes two parts: an index segment and a data segment. The index segment is configured to save version information and an index number of data, and the data segment is configured to save data. The second shared memory may further compress the saved data by means of a data compression technique of data key value sharing. For example, for IP data, multiple pieces of IP data corresponding to the same geographic information may be combined into one IP segment. If IP1, IP2, and IP3 are continuous and correspond to the same geographic information, IP1, IP2, and IP3 may be combined into one IP segment IP1_IP3. For geographic information, the geographic information may be converted into an ID and then saved. For example, China may be saved as a code “1”, US may be saved as a code “2”, and so on.

In this way, the amount of data after compression may be compressed to 10% of the original amount of data, so that the use cost of the memory of the client can be reduced, and massive data can be stored in the client. Here, the process in which the data obtaining module writes the specified data into the second shared memory may include: performing rewriting in the index segment in the second shared memory according to version information and an index number of the specified data, and writing the specified data into the data segment of the second shared memory.

The data obtaining module and the data service module may exchange data through the Ask protocol. Here, the Ask protocol is an application layer private protocol based on a User Datagram Protocol (UDP), and configured as a data request, which is mainly categorized into three packets including reset, ask, and data. Reset is used to force a client to obtain data of a specified version, ask is used to indicate the version and an index number of the data that is requested by the client, and Data is the specific data delivered by a server. A heartbeat between the client and the server is carried out by using an ask packet. In practical application, the data obtaining module may operate in an online mode and an offline mode. Specifically, after obtaining data from the data service module by using a heartbeat contact, the data obtaining module stays as an online module, performs a heartbeat contact with the data service module periodically by using the Ask protocol, and obtains data of a latest version from the data service module periodically by using the heartbeat contact; after obtaining data from the data service module by using a heartbeat contact, the data obtaining module is set to an offline mode, no longer maintains the heartbeat contact with the data service module, and is adjusted to the online mode as required to obtain data from the data service module again.

In practical application, if data is obtained for the first time, the data obtaining module initiates a data obtaining request to the proxy server, and indicates, in the data obtaining request, a request for obtaining full data of a latest version; and receives the full data returned by the data service module, and writes the full data into the second shared memory. Accordingly, the data service module queries the full data of the latest version from the first shared memory according to the data obtaining request that indicates the request for obtaining the full data of the latest version, and returns the full data to the data obtaining module.

If data is obtained for the second time, the data obtaining module initiates a data obtaining request to the proxy server, and makes the data obtaining request carry an index number range of data to be obtained and version information, in the second shared memory, of the data to be obtained; and receives incremental data or full data returned by the data service module, combines the incremental data with corresponding full data in the second shared memory (here, the corresponding full data is full data corresponding to the version information carried in the data obtaining module) to generate full data of a latest version, and writes the full data of the latest version into the second shared memory.

Or for full data, the data obtaining module may write the full data returned by the data service module into the second shared memory directly. Accordingly, the data service module receives the data obtaining request, queries version information, in the first shared memory, of data within the index number range of the data obtaining request, and determines whether a time difference between the version information in the data obtaining request and the version information queried from the first shared memory is greater than a preset version threshold, and if the time difference is not greater than the preset version threshold, queries, from the first shared memory, incremental data having version information not earlier than the version information in the data obtaining request and having an index number within the index number range, and returns the incremental data to the data obtaining module, or if the time difference is greater than the preset version threshold, queries full data of a latest version from the first shared memory and returns the full data to the data obtaining module. For example, if the data service module determines that the time difference between the version information in the data obtaining request and the local latest version information exceeds one month, the data service module queries full data of the latest version and returns the full data to the data obtaining module; if the data service module determines that the time difference between the version information in the data obtaining request and the local latest version information does not exceed one month, the data service module queries incremental data having version information not earlier than the version information in the data obtaining request, and returns the incremental data to the data obtaining module. The incremental data represents changed data of full data before update as compared with full data after update.

Here, the embodiment of the present invention can also implement forced data rollback. Specifically, when the data provider finds erroneous data, the data service module of the proxy server sends to the proxy client a data reset message that indicates forced data update, and instructs the proxy client to update full data; the data obtaining module of the proxy client receives the data reset message that indicates forced data update, initiates a data obtaining request to the proxy server, and indicates, in the data obtaining request, a request for obtaining full data of a latest version; then, the data service module of the proxy server queries the full data of the latest version from the first shared memory according to the data obtaining request that indicates the request for obtaining the full data of the latest version, and returns the full data to the proxy client; and finally, the data obtaining module of the proxy client receives the full data returned by the proxy server, and writes the full data into the second shared memory. In this way, erroneous data is found (for example, an error occurs in the data computing system or erroneous data is transmitted), data can be fully rolled back in time, so that data of the client is immediately restored to full data of a latest version, thereby preventing the applier from querying and using erroneous data. The data reset message that indicates forced data update may contain version information and an index number range of data to be updated.

Specifically, the data query module is specifically configured to query data specified by the applier from the second shared memory in a manner of a UDP packet query and/or a manner of application programming interface (API) invocation, and return the data to the applier. In this way, a data query can by implemented through local memory access in the client, the network bandwidth bottleneck can be broken, the data query capability can be improved by one order of magnitude, and the client can still obtain a stable and efficient query service normally when the network between the client and the server is unavailable.

Here, the data query module may include a first data query sub-module and/or a second data query sub-module. The first data query sub-module is configured to provide the applier with a UDP packet query service, namely, to receive a UDP query packet (for example, an IP query packet) sent by the applier through the network, search the second shared memory for corresponding data (for example, IP data including a mapping between an IP address and geographic information) according to the query packet, obtain a query result, and return the query result to the applier by using a UDP packet. The second data query sub-module is configured to provide the applier with a query service of API invocation, namely, to accept invocation of the applier, query corresponding data from the second shared memory according to a query condition provided by the applier, generate a query result, and return the query result to the applier.

In practical application, the second data query sub-module may specifically be an API function configured to query specified data from the second shared memory, and the applier may invoke the API function in codes to query the required data. In this way, high-frequency and low-delay data access can be provided to the applier, and the efficiency is one order of magnitude higher than that in the conventional network mode.

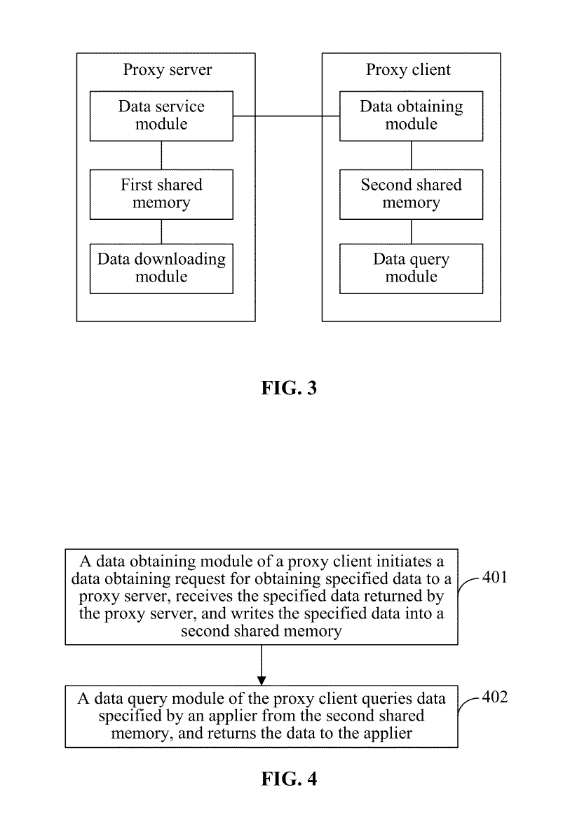

In practical application, the proxy server may be software installed on a hardware device (for example, a server) on the server, and the proxy client is software installed on a hardware device (for example, a server, a personal computer (PC), or the like) on the client. When the applier on the client requires a data query service, only the proxy client needs to be installed on the client, so as to exchange data with the server, obtain data, and perform a data query. Accordingly, an embodiment of the present invention further provides a data query method implemented by using the foregoing data query system. As shown in FIG. 4, the method may mainly include the following steps:

In Step 401: the data obtaining module of the proxy client initiates a data obtaining request for obtaining specified data to the proxy server, receives the specified data returned by the proxy server, and writes the specified data into the second shared memory.

In Step 402: the data query module of the proxy client queries data specified by an applier from the second shared memory, and returns the data to the applier.

Before Step 401, the method may further include: obtaining, by the data downloading module of the proxy server, a data file from outside, and writing data in the data file into the first shared memory; and receiving, by the data service module of the proxy server, a data obtaining request initiated by the proxy client, querying specified data from the first shared memory according to the data obtaining request, and returning the specified data to the proxy client through a network.

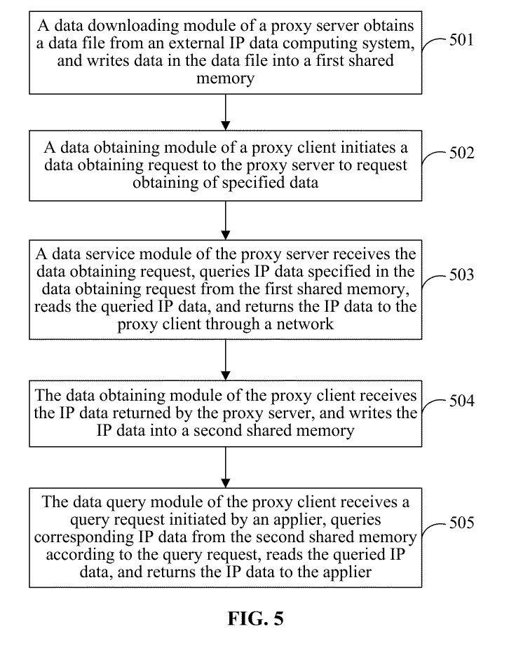

As shown in FIG. 5, the process of implementing an IP data (namely, mapping data of IP addresses to geographic information) query through the data query system according to the embodiment of the present invention may specifically include the following steps:

In Step 501: the data downloading module of the proxy server obtains a data file from an external IP data computing system, and writes data in the data file into the first shared memory.

Specifically, after the IP data computing system obtains, through computation, a data file containing IP data, the data downloading module of the proxy server accesses the IP data computing system, obtains the data file from the IP data computing system, writes the IP data in the data file into the data segment area of the first shared memory, and writes version information of the data file and an index number of each piece of IP data into the index segment area of the first shared memory.

In Step 502: the data obtaining module of the proxy client initiates a data obtaining request to the proxy server to request obtaining of specified data.

Specifically, if the proxy client requests obtaining of data for the first time, the data obtaining request indicates a request for obtaining full data in a specified index number range; if the proxy client requests obtaining of data not for the first time, the data obtaining request initiated to the proxy server carries an index number range and version information of data to be obtained.

Step 503: The data service module of the proxy server receives the data obtaining request, queries IP data specified in the data obtaining request from the first shared memory, reads the queried IP data, and returns the IP data to the proxy client through a network.

Specifically, if the data obtaining request indicates a request for obtaining full IP data in a specified index number range, the data service module queries from the first shared memory full IP data of a latest version within the specified index number range, reads the full IP data of the latest version, and returns the full IP data to the proxy client. If the data obtaining request carries an index number range and version information of IP data to be obtained, the data service module queries corresponding version information from the first shared memory according to the index number range of the IP data to be obtained, and determines whether a time difference between the version information in the data obtaining request and the queried version information is within a preset version threshold. If the time difference is greater than the preset version threshold, the data service module queries, from the first shared memory, incremental IP data having version information not earlier than the version information in the data obtaining request and having an index number within the index number range, reads the queried incremental IP data, and returns the incremental IP data to the proxy client. If the time difference is not greater than the preset version threshold, the data service module queries, from the first shared memory, full IP data of a latest version within the index number range in the data obtaining request, reads the queried full IP data, and returns the full IP data to the proxy client.

In Step 504: the data obtaining module of the proxy client receives the IP data returned by the proxy server, and writes the IP data into the second shared memory.

Specifically, the data obtaining module of the proxy client writes the IP data into the data segment area of the second shared memory, and writes version information and an index number of the IP data into the index segment area of the second shared memory.

Here, if the proxy server returns full IP data, the proxy client writes the full IP data into the second shared memory directly, and updates version information and an index number of the full IP data; if the proxy server returns incremental IP data, the proxy client combines the incremental IP data with corresponding full IP data in the second shared memory to generate full IP data of a latest version, then writes the full IP data into the second shared memory, and updates version information and an index number thereof

In Step 505: the data query module of the proxy client receives a query request initiated by an applier, queries corresponding IP data from the second shared memory according to the query request, reads the queried IP data, and returns the IP data to the applier.

Specifically, the data query module of the proxy client receives the query request initiated by the applier, queries data specified by the applier from the second shared memory in a manner of a UDP packet query and/or in a manner of API invocation, and returns the data to the applier.

When a UDP query packet sent by the applier through the network is received, the second shared memory is searched according to the UDP query packet for corresponding IP data, a query result containing the queried IP data is obtained, and the query result is returned to the applier by using a UDP packet.

After the applier inputs a query condition (namely, the query request) in codes, invocation of the applier is accepted, corresponding IP data is queried from the second shared memory according to the query condition provided by the applier, and a query result containing the queried IP data is generated and returned to the applier.

Here, if erroneous data is found, the foregoing procedure of querying IP data may further include the following data rollback procedure, which may specifically include the following steps (not shown in FIG. 5).

In Step a1: the data service module of the proxy server sends to the proxy client a data reset message that indicates forced data update, and instructs the proxy client to update full data.

In Step a2: the data obtaining module of the proxy client receives the data reset message that indicates forced data update, initiates a data obtaining request to the proxy server, and indicates, in the data obtaining request, a request for obtaining full data of a latest version.

In Step a3: the data service module of the proxy server queries the full data of the latest version from the first shared memory according to the data obtaining request that indicates the request for obtaining the full data of the latest version, reads the full data, and returns the full data to the proxy client.

In Step a4: the data obtaining module of the proxy client receives the full data returned by the proxy server, and writes the full data into the second shared memory.

It should be noted that, the foregoing data query system and data query method according to the embodiments of the present invention may be applied to a query for data such as media access control (MAC) data (representing a mapping between a MAC address and geographic information), global positioning system (GPS) data, and mobile phone number data (representing a mapping between a mobile phone number and geographic information), for example, applied to a service such as GPS positioning and mobile number location query.

Additionally, the present disclosure further provides a non-transitory computer readable storage medium, having program(s) stored thereon. When the program(s) are executed, the program(s) may cause processor(s) to enable a computing device or a computer (e.g., a proxy client) to implement the disclosed data query methods. For example, a data obtaining module of a proxy client (e.g., a computing device) initiates a data obtaining request for obtaining specified data to a proxy server, receives the specified data returned by the proxy server, and writes the specified data into a second shared memory. A data query module of the proxy client queries data specified by an applier from the second shared memory, and returns the data to the applier.

The foregoing descriptions are merely preferred embodiments of the present invention, but are not intended to limit the protection scope of the present disclosure. Other applications, advantages, alternations, modifications, or equivalents to the disclosed embodiments are obvious to those skilled in the art and are intended to be encompassed within the scope of the present disclosure.

What is claimed is:

1. A data query system, comprising:
a proxy server and at least one proxy client, wherein:
the proxy server is disposed on a server that serves as a data provider, and is configured to provide the proxy client with a data delivery service; and
the proxy client is disposed on a client that serves as a data user, and is configured to obtain data from the proxy server and save the data and provide a data query service, wherein the proxy client comprises:
a data obtaining module, configured to initiate a data obtaining request for obtaining specified data from the proxy server, receive the specified data returned by the proxy server, and write the specified data into a second shared memory,
a data query module, configured to query data specified by an applier from the second shared memory, and return the data to the applier, and
the second shared memory, configured to store the data written by the data obtaining module and to be queried by the data query module.

2. The data query system according to claim 1, wherein the proxy server comprises: a data downloading module, a data service module, and a first shared memory, wherein:
the data downloading module is configured to obtain a data file from outside, and write data in the data file into the first shared memory;
the data service module is configured to receive a data obtaining request initiated by the proxy client, query specified data from the first shared memory according to the data obtaining request, and return the specified data to the proxy client through a network; and
the first shared memory is configured to store the data written by the data downloading module and to be queried by the data service module.

3. The data query system according to claim 1, wherein the data query module of the proxy client is configured to query the data specified by the applier from the second shared memory in a manner including one or more of a User Datagram Protocol (UDP) packet query and an application programming interface (API) invocation, and return the data to the applier.

4. The data query system according to claim 3, wherein the data query module of the proxy client comprises one or more of a first data query sub-module and a second data query sub-module, wherein:
the first data query sub-module is configured to receive a UDP query packet sent by the applier through a network, search the second shared memory according to the UDP query packet for corresponding data, obtain a query result, and return the query result to the applier by using a UDP packet; and
the second data query sub-module is configured to accept invocation of the applier, query corresponding data from the second shared memory according to a query condition provided by the applier, generate a query result, and return the query result to the applier.

5. The data query system according to claim 2, wherein each of the first shared memory and the second shared memory comprises an index segment and a data segment, the index segment is configured to save version information and an index number of data, and the data segment is configured to save data, and compress the saved data by a data compression technique using data key-value sharing.

6. The data query system according to claim 5, wherein:
the data obtaining module of the proxy client is configured to initiate a data obtaining request from the proxy server, and indicate, in the data obtaining request, a request for obtaining full data of a latest version; and receive the full data returned by the data service module of the proxy server, and write the full data into the second shared memory; and
the data service module of the proxy server is configured to query the full data of the latest version from the first shared memory according to the data obtaining request that indicates the request for obtaining the full data of the latest version, and return the full data to the data obtaining module.

7. The data query system according to claim 5, wherein:
the data obtaining module of the proxy client is configured to initiate a data obtaining request from the proxy server, and enable the data obtaining request to carry an index number range of data to be obtained and version information, in the second shared memory, of the data to be obtained; and receive incremental data or full data returned by the data service module, write the full data into the second shared memory directly, or combine the incremental data with corresponding full data in the second shared memory to generate full data of a latest version, and write the full data of the latest version into the second shared memory; and
the data service module of the proxy server is configured to receive the data obtaining request, query version information, in the first shared memory, of data within the index number range of the data obtaining request, and determine whether a time difference between the version information in the data obtaining request and the version information queried from the first shared memory is greater than a preset version threshold, and, if the time difference is not greater than the preset version threshold, query, from the first shared memory, incremental data having version information not earlier than the version information in the data obtaining request and having an index number within the index number range, and return the incremental data to the data obtaining module, or if the time difference is greater than the preset version threshold, query full data of a latest version from the first shared memory and return the full data to the data obtaining module.

8. The data query system according to claim 5, wherein:
the data service module of the proxy server is further configured to send a data reset message that indicates a forced data update to the proxy client, and instruct the proxy client to update full data; and query the full data of the latest version from the first shared memory according to the data obtaining request that indicates the request for obtaining the full data of the latest version, and return the full data to the proxy client; and
the data obtaining module of the proxy client is further configured to receive the data reset message that indicates the forced data update, initiate a data obtaining request from the proxy server, and indicate, in the data obtaining request, a request for obtaining full data of a latest version; and receive the full data returned by the proxy server, and write the full data into the second shared memory.

9. The data query system according to claim 1, wherein the data is Internet Protocol (IP) data representing a mapping between an IP address and geographic information, or is media access control (MAC) data representing a mapping between a MAC address and geographic information, or is mobile phone number data representing a mapping between a mobile phone number and geographic information, or is global positioning system (GPS) positioning data.

10. The data query system according to claim 1, wherein the proxy server and the proxy client communicate with each other by using a general data request (Ask) protocol.

11. A data query method, implemented by a data query system, comprising:
providing the data query system comprising a proxy server and at least one proxy client, wherein the proxy server is disposed on a server that serves as a data provider to provide the proxy client with a data delivery service, and the proxy client is disposed on a client that serves as a data user, to obtain data from the proxy server to save the data and to provide a data query service by a process comprising:
initiating, by a data obtaining module of the proxy client, a data obtaining request for obtaining specified data from the proxy server,
receiving, by the data obtaining module of the proxy client, the specified data returned by the proxy server,
writing, by the data obtaining module of the proxy client, the specified data into a second shared memory,
querying, by a data query module of the proxy client, data specified by an applier from the second shared memory, and
returning, by the data query module of the proxy client, the data to the applier.

12. The data query method according to claim 11, wherein the data query module of the proxy client queries the data specified by the applier from the second shared memory in a manner including one or more of a User Datagram Protocol (UDP) packet query and an application programming interface (API) invocation, and returns the data to the applier.

13. The data query method according to claim 12, wherein:
the data query module of the proxy client receives a UDP query packet sent by the applier through a network, searches the second shared memory according to the UDP query packet for corresponding data, obtains a query result, and returns the query result to the applier by using a UDP packet; and/or
the data query module of the proxy client accepts invocation of the applier, queries corresponding data from the second shared memory according to a query condition provided by the applier, generates a query result, and returns the query result to the applier.

14. The data query method according to claim 11, wherein the method comprises:
obtaining, by a data downloading module of the proxy server, a data file from outside, and writing data in the data file into a first shared memory; and
receiving, by a data service module of the proxy server, a data obtaining request initiated by the proxy client, querying specified data from the first shared memory according to the data obtaining request, and returning the specified data to the proxy client through a network.

15. The data query method according to claim 11, wherein:
the data obtaining module of the proxy client initiates a data obtaining request to the proxy server, and indicates, in the data obtaining request, a request for obtaining full data of a latest version;
the data service module of the proxy server queries the full data of the latest version from the first shared memory according to the data obtaining request that indicates the request for obtaining the full data of the latest version, and returns the full data to the proxy client; and
the data obtaining module of the proxy client receives the full data returned by the proxy server, and writes the full data into the second shared memory.

16. The data query method according to claim 11, wherein:
the data obtaining module of the proxy client initiates a data obtaining request to the proxy server, and enables the data obtaining request to carry an index number range of data to be obtained and version information, in the second shared memory, of the data to be obtained;
the data service module of the proxy server receives the data obtaining request, queries version information, in the first shared memory, of data within the index number range of the data obtaining request, and determines whether a time difference between the version information in the data obtaining request and the version information queried from the first shared memory is greater than a preset version threshold, and if the time difference not greater than the preset version threshold, queries, from the first shared memory, incremental data having version information not earlier than the version information in the data obtaining request and having an index number within the index number range, and returns the incremental data to the data obtaining module, or if the time difference is greater than the preset version threshold, queries full data of a latest version from the first shared memory and returns the full data to the proxy client; and
the data obtaining module of the proxy client receives the incremental data or full data returned by the proxy server, writes the full data into the second shared memory directly, or combines the incremental data with corresponding full data in the second shared memory to generate full data of a latest version, and writes the full data of the latest version into the second shared memory.

17. The data query method according to claim 11, wherein:
the data service module of the proxy server sends to the proxy client a data reset message that indicates forced data update, and instructs the proxy client to update full data;
the data obtaining module of the proxy client receives the data reset message that indicates forced data update, initiates a data obtaining request to the proxy server, and indicates, in the data obtaining request, a request for obtaining full data of a latest version;
the data service module of the proxy server queries the full data of the latest version from the first shared memory according to the data obtaining request that indicates the request for obtaining the full data of the latest version, and returns the full data to the proxy client; and
the data obtaining module of the proxy client receives the full data returned by the proxy server, and writes the full data into the second shared memory.

18. The data query method according to claim 11, wherein the data is Internet Protocol (IP) data representing a mapping between an IP address and geographic information, or media access control (MAC) data representing a mapping between a MAC address and geographic information, or mobile phone number data representing a mapping between a mobile phone number and geographic information, or global positioning system (GPS) data.

19. A non-transitory computer readable storage medium comprising a program stored thereon, wherein, when being executed, the program causes one or more processors of a proxy client to perform a data query method comprising:
initiating, by a data obtaining module of the proxy client, a data obtaining request for obtaining specified data from a proxy server,
receiving, by the data obtaining module of the proxy client the specified data returned by the proxy server,
writing, by the data obtaining module of the proxy client, the specified data into a second shared memory,
querying, by a data query module of the proxy client, data specified by an applier from the second shared memory, and
returning, by the data query module of the proxy client, the data to the applier.
